(19) United States
(12) Patent Application Publication
(10) Pub. No.: US 2015/0083832 A1
(43) Pub. Date: Mar. 26, 2015

(54) METHOD AND SYSTEM FOR RECOVERING COPPER FROM AUTOMOBILE SHREDDER RESIDUE

(71) Applicant: VHIP LLC, Atlanta, GA (US)

(72) Inventor: Thomas A. Valerio, Atlanta, GA (US)

(21) Appl. No.: 14/491,345

(22) Filed: Sep. 19, 2014

Related U.S. Application Data
(60) Provisional application No. 61/880,217, filed on Sep. 20, 2013.

(51) Int. Cl. C22B 15/00; C22B 7/00; B07B 4/02; B02C 23/38; B02C 23/08

(52) U.S. Cl. CPC C22B 15/00; B02C 23/38; B02C 23/08; B07B 4/02; C22B 7/005
USPC 241/19; 241/43

(57) ABSTRACT

Processing copper wire concentrate produced from processing ASR to generate a bare copper product. The disclosed systems and methods employ processes that remove constituents from the copper wire concentrate that can damage conventional chopping equipment. After removing the constituents that can damage conventional chopping equipment, the process employs a grinder to grind the remaining copper wire to liberate the bare copper metal from the insulation material.

### CROSS-REFERENCE TO RELATED APPLICATIONS

The present application claims priority under 35 U.S.C. Section 119(e) to U.S. Provisional Patent Application No. 61/880,217, filed Sep. 20, 2013, and titled “Method And System For Chopping Copper Wire Concentrate Recovered From Automobile Shredder Residue,” the entire content of which is incorporated herein by reference.

### FIELD OF THE INVENTION

This invention relates to systems and methods for recovering bare copper metal from copper wire concentrate recovered during the recovery of metals and other materials from automobile shredder residue (ASR). More specifically, this invention relates to systems and methods for separating insulator material on copper wire from the wire after the copper wire has been concentrated by processing the ASR, where the copper wire concentrate is contaminated by non-copper metal constituents.

### BACKGROUND OF THE INVENTION

Recycling of waste materials is highly desirable from many viewpoints, not the least of which are financial and ecological. Properly sorted recyclable materials can often be sold for significant revenue. Many of the more valuable recyclable materials do not biodegrade within a short period, and so their recycling significantly reduces the strain on local landfills and ultimately the environment.

Typically, waste streams are composed of a variety of types of waste materials. One such waste stream is generated from the recovery and recycling of automobiles characterized by the fact that a majority of the material (typically over 65%) is made of ferrous metal. For examples, at the end of its useful life, an automobile is shredded. This shredded material is processed (by one or more large drum magnets) to recover most of the ferrous metal contained in the shredded material. The remaining materials, referred to as automobile shredder residue, or ASR, may still include ferrous and non-ferrous metals, including copper wire and other recyclable materials. ASR is mainly made of non-metallic material (dirt, dust, plastic, rubber, wood, foam, et cetera), non-ferrous metals (mainly aluminum but also brass, zinc, stainless steel, lead, and copper) and some remaining ferrous metal that was not recovered by the first main ferrous recovery process (that is, the drum magnets).

The ASR resulting from the recovery of much of the ferrous metal in the waste stream is referred to as “virgin” ASR. L. Fabrizi et al. provides a characterization of typical virgin ASR. ASR includes 23 percent elastomers; 13 percent glass and ceramics; 13 percent chlorine free thermosets and form parts; 13 percent iron; 7 percent foam material; 6 percent polyvinyl chloride (PVC); 6 percent other fibers and cover-materials; 5 percent other components; 4 percent wood, paper, and cardboard; 3 percent aluminum; 3 percent other thermosets; 3 percent paint; and 1 percent copper. See L. Fabrizi et al., Wire Separation from Automobile Shredder Residue, PHYSICAL SEPARATION IN SCIENCE AND ENGINEERING, Vol. 12, No. 3, pp. 145-165 (2003). In addition to the diversity of the nature of the materials in ASR, the materials are present in ASR in different shapes and sizes. The large differences in sizes is explained by the size of the shredders used in the ASR industry and explained by the size of the rack pieces (cars, trucks, etc.) that enter the shredders, which is unique to ASR as compared to other waste materials. The diversity of material shapes is explained in part by the varying nature of the material.

This combination of diverse materials and diverse material size and shape provides a unique challenge in separating and recycling specific materials in an efficient manner. The ability to efficiently separate and concentrate recyclable materials from the ASR reduces the negative environmental impact of these materials, as less of this residue will be disposed of in landfills.

A typical automobile has about 65 pounds of copper, 50 percent of which is in the form of copper wiring. ASR typically includes about 0.5% to 2.5% of copper wire. The value of copper today makes recovering the copper from ASR of financial as well as environmental interest.

Copper wire provides a unique challenge in recovering materials from ASR. Copper is non-ferrous metal, so recovery processes that employ magnets cannot be used. Processes that are typically used to recovery non-ferrous metals, such as eddy current separators, is less effective for separating copper than other non-ferrous metals. Often, copper wire was recovered from ASR manually, with worker hand-picking the wire from the waste material. Recently, certain innovations have solved the problem of concentrating copper by further processing an ASR waste stream. For example, such technologies are described in U.S. Pat. Nos. 7,658,291; 8,360,242; and 8,360,347. Such technologies are also described in U.S. patent application Ser. Nos. 12/917,159 (published as U.S. Patent Pub. 2011/0147501) and 13/616,948 (published as U.S. Patent Pub. 2013/0008832). The entire disclosures of these listed patents and patent applications are incorporated by reference herein.

The known processes for concentrating copper wire from ASR can increase the copper wire concentration from the typical range of 0.5 percent to 2.5 percent in virgin ASR, to a range of 25 percent to as high as 90 percent copper wire in the copper wire concentrate. Although these processes can concentrate the copper wire, most of the wires still include most of their insulating material. The copper content, in weight, of insulated copper wires present in ASR typically varies from 35 to 55%. Also, depending on the methods used to concentrate the copper wire, other metal and non-metallic materials can be tangled with the wire pieces. The presence of the insulation material and other metal and non-metallic material reduces the overall copper content, in weight, of the concentrated copper wire and, as a result of that, its value, necessitating further processing to increase the copper content and maximize the revenue potential from the recovered copper.

Processes are known to “chop” copper wire to liberate the bare metal from insulation. Traditional chopping technology for insulated copper wires includes tube grinders made of a steel rotor on which are mounted cutter blades that typically rotate between 200 and 700 rpm. These grinders are designed to chop insulated copper wires and can tolerate possible contaminants if those contaminants are not harder and much more massive than the copper wires and their insulators. Otherwise, the grinder blades can be damaged by the contaminants. Copper wire feeding this wire chopping process is typically industrial copper wire tailings and wire waste, where there is little risk of contaminants that will harm the grinder blades. As mentioned above, copper wire concentrate from processing ASR can have contaminants, including both metallic and non-metallic constituents. Some of these contaminants are likely harder than copper and its insulation. The varied content of ASR and the presence of anywhere from 10 percent to seventy-five percent of non-copper-wire constituents in the concentrate makes the concentrate problematic for traditional chopping technologies.

The main metal contaminant that presents a problem to the grinders is stainless steel, which is typically found in concentrations of up to 10% of the copper wire concentrate depending on the technology used to recover the copper wire. Stainless steel poses a problem for grinders primarily because of its hardness. As used herein, “hardness” means indention hardness, or the resistance of a material to plastic deformation. A variety of known tests in the art can measure indention hardness, such as Rockwell hardness test, Brinell hardness test, Vickers hardness test, or the like (although as used here, the term “hardness” is independent of any specific test protocol). For example, copper used in copper wire has a Brinell hardness of approximately 35 HB. By comparison, stainless steel has Brinell hardness values of over 100 HB or even over 200 HB, depending on the grade of stainless steel.

Another metal contaminant that may be found in the copper wire concentrate that could potentially cause damage to the grinders is lead, because of its high density. Lead does not have the hardness of copper. For example, pure lead has a Brinell hardness of approximately 5.0 HB (Brinell hardness for alloyed lead typically can range from 5.0 HB to values in excess of 22.0 HB). Also, copper itself presents a problem to grinder blades if it's not in the form of typical copper wire, for example in the form of a bar or tube. These bars and tubes are thicker than copper wire and this thickness poses a damage risk to the grinder blades. Thickness is the measure of the dimension between two surfaces of an object that is the dimension of the smallest measure.

Accordingly, considerations of whether metallic contaminants in copper wire concentrate may damage grinder blades include the hardness of the material as well as the overall density of the contaminant and the size of the contaminant constituents.

In view of the foregoing, a need exists for a method and system that can separate the copper metal component of a copper wire concentrate recovered during the processing of ASR from insulation material and other metallic and non-metallic components of ASR. The system and method must tolerate the presence of materials that are harder than copper wire and its insulation material or that, because of their possible large and thick size or density, can damage the grinders.

### SUMMARY OF THE INVENTION

The present invention provides methods and systems for producing bare copper metal from a concentrate of copper wiring separated during the processing of ASR while tolerating contaminants that are possibly harder and thicker than the typical copper wire and its insulating material.

One aspect of the present invention provides a method for recovering bare copper metal from an ASR copper wire concentrate. The method includes the steps of: (1) receiving the ASR copper wire concentrate includes a copper wire component and a non-copper metal component, the copper wire component including copper metal and an insulation material, where the non-copper metal component has a density greater than the density of copper or a hardness value greater than a hardness value of copper, or a thickness greater than the thickness of the copper wire component; (2) processing the ASR copper wire concentrate in a shredder; (3) separating the shredded ASR copper wire concentrate into a light fraction and a heavy fraction using an air classifier, where the light fraction includes the copper wire component and where the heavy fraction includes the non-copper metal component; and (4) processing the light fraction in a grinder to liberate the copper metal of the copper wire component from the insulation material.

Another aspect of the present invention provides a system for recovering bare copper metal from an ASR copper wire concentrate. The system includes: a shredder for processing the ASR copper wire concentrate, the ASR copper wire concentrate including a copper wire component and a non-copper metal component, the copper wire component including copper metal and an insulation material, where the non-copper metal component a density greater than the density of copper, a hardness value greater than a hardness value of copper, or a thickness greater than the thickness of the copper wire component; an air classifier for separating the shredded ASR copper wire concentrate into a light fraction and a heavy fraction, where the light fraction includes the copper wire component and where the heavy fraction includes the non-copper metal component; and a grinder for processing the light fraction to liberate the copper metal of the copper wire component from the insulation material.

### BRIEF DESCRIPTION OF THE DRAWINGS

FIG. 1 depicts a system diagram for recovering copper from copper wire concentrate in accordance with an exemplary embodiment of the present invention; and

FIG. 2 depicts a process flow diagram for recovering copper from copper wire concentrate in accordance with an exemplary embodiment of the present invention.

### DETAILED DESCRIPTION OF THE EXEMPLARY EMBODIMENTS

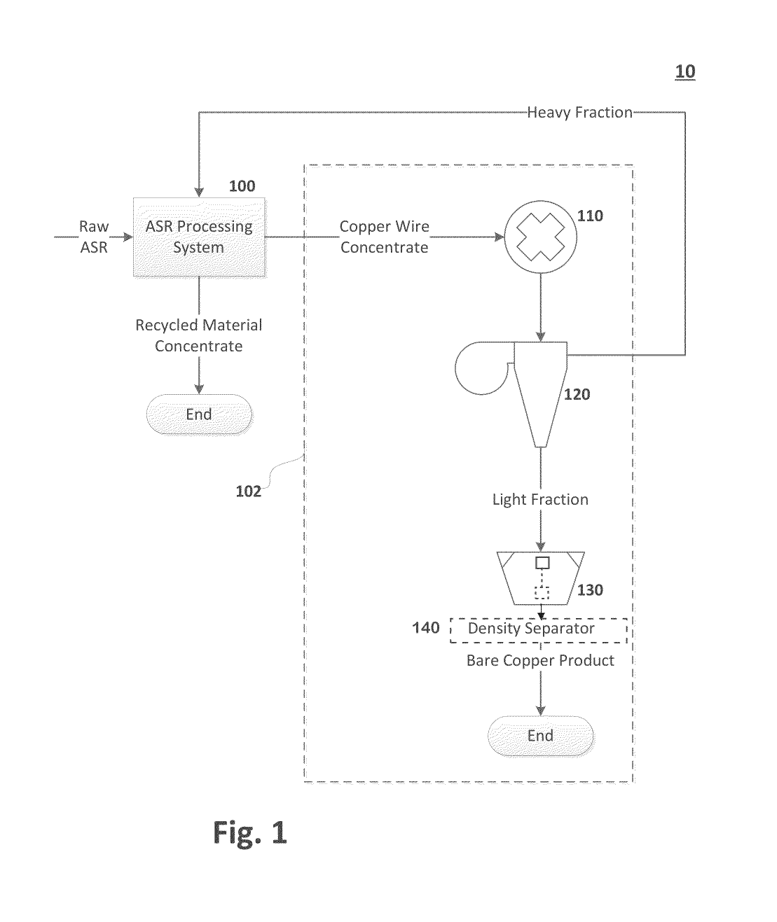

Exemplary embodiments of the present invention provide systems and methods for recovering the bare copper component of copper wiring concentrated by processing ASR while tolerating contaminants that are harder than copper wire and its insulating material. FIG. 1 depicts a system diagram for a system 10 for recovering copper from copper wire concentrate in accordance with an exemplary embodiment of the present invention. Referring to FIG. 1, raw ASR is processed in an ASR processing system 100. The ASR processing system 100 may process the raw ASR and produce copper wire concentrate. In some example embodiments, the ASR processing system 100 may also produce recycled material concentrate. The ASR processing system 100 may include a variety of known methods for concentrating certain components of raw ASR, such as certain types of plastics, certain ferrous and non-ferrous metals, and copper wiring. These concentrates are recycled and eliminated from the waste stream, reducing the ultimate amount of waste disposed of in a landfill.

The present disclosure is applicable to copper wire concentrate generated from the processing of ASR and received directly after the ASR is produced. That is, after the automobile is shredded and ferrous metals are removed, producing the ASR, that ASR is then processed in the ASR processing system 100 to produce copper wire concentrate. The present disclosure is also applicable to copper wire concentrate that is derived from ASR that is mined from a landfill. Although ASR processing is currently performed, previously, ASR was disposed of without any further processing. Accordingly, copper wiring was disposed of along with the rest of the ASR. One potential source of raw or virgin ASR is ASR waste disposed in landfill that still holds some copper wiring.

A copper wiring concentrate is received into system 102, which processes the copper wiring concentrate to generate a bare copper product. The copper wiring concentrate ranges in copper wire concentration from between 25 percent and 90 percent. The remaining constituents of the copper wire concentrate include other ASR components including non-copper-wire metal components (e.g., stainless steel, lead, etc.). These non-copper-wire metal components “contaminants” can damage traditional grinders. For example, a non-copper metal component of the copper wire concentrate may have a density that is greater than the density of copper. Alternatively or in addition, the non-copper metal component may also have a hardness value that greater than a hardness value of copper. Further, the non-copper metal component may also have a thickness that is greater than the thickness of the copper wire component of the copper wire concentrate.

The copper wire concentrate is processed in a shredder 110. The shredder 110 may be a hammer mill or ring mill or similar type shredder that can process non-copper metal components that may be a contaminant in the copper wire concentrate. In an exemplary embodiment, the shredder 110 reduces the copper wire concentrate to a size of about 0.75 inches (1.9 centimeters). The shredding process also detangles the copper wire concentration, which frees entangled contaminants.

The shredded copper wire concentrate is then processed in an air classifier 120. An air classifier typically has a chamber in which a mixed solid material falls by gravity. A counter current flow of air entrains light-weight constituents of the material while heavy constituents fall to the bottom of the classifier. Within the shredded copper wire concentrate, the desired pieces of wire, which may still have insulation material, would be entrained in the light fraction of constituents while heavier metal constituents, which would damage a traditional grinder, would be in the heavy fraction. In this way, the constituents in the copper wire concentrate that would damage a grinder are separated from the copper wire component. The light fraction, which includes the copper wire, and the heavy fraction from the air classifier 120 are separately collected. The heavy fraction may be returned to the ASR processing system 100 to recover the heavy metal constituents (e.g., stainless steel, lead, and/or other non-copper metal components) or sold as-is, since this material has a value as a recycled material as is.

The light fraction is processed in one or more grinders 130, placed in series. The one or more grinders 130 separate the copper constituent from the insulation over the copper wire. As a result, a bare copper product is produced. Further, the grinder is not damaged by contaminants in the feed stream, as these contaminants are removed at the air classifier 120. In some example embodiments, the separated copper and insulation constituents are then separated one from another by known technologies like density-based separation using one or more density separators 140 taking advantage of the significant density difference between copper (8.940 kg/m³) and the insulation material, which is typically below 2.00 kg/m³.

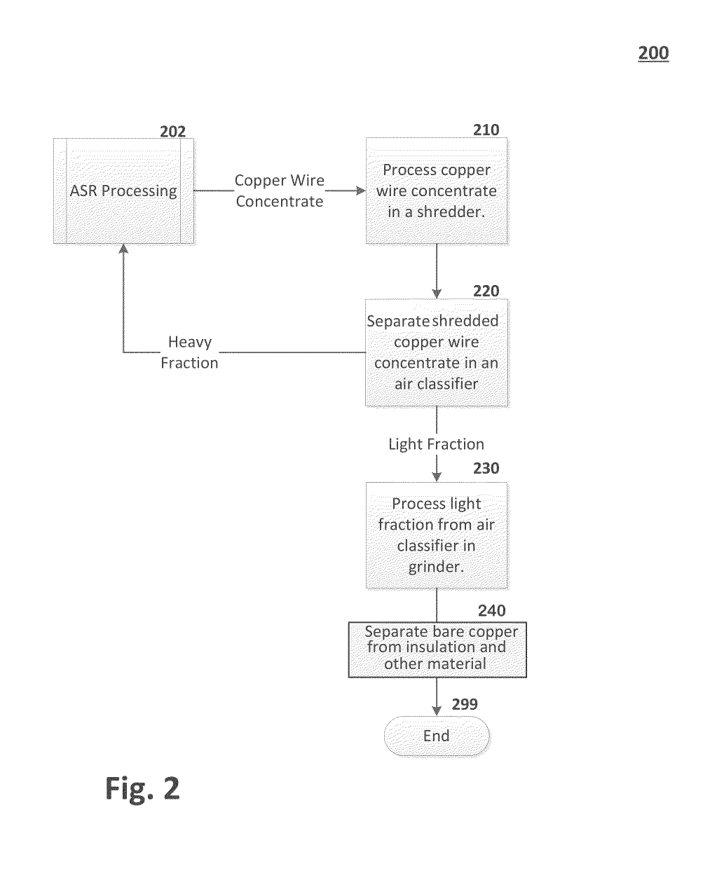

FIG. 2 depicts a process flow diagram for a process 200 for recovering copper from copper wire concentrate in accordance with an exemplary embodiment of the present invention. Referring to FIGS. 1 and 2, at step 202, conventional ASR processing generates a copper wire concentrate, ranging in copper wire concentration from between 25 percent and 90 percent.

The copper wire concentrate is received and processed in a shredder, such as shredder 110, at step 210. At step 210, the shredder reduces the copper wire concentrate to a size of about 0.75 inches (1.9 centimeters). The resulting shredded copper wire concentrate is consistent in size and is detangled, which frees the contaminants that were trapped among the tangled wire pieces of the copper wire concentrate.

At step 220, the shredded copper wire concentrate produced at step 210 is processed in an air classifier, such as air classifier 120. At step 220, the shredded copper wire concentrate is separated into a heavy fraction and a light fraction. The heavy fraction falls through the chamber of the air classifier, and the light fraction is entrained in the counter-flowing air stream.

Light fraction includes the copper wire component of the copper wire concentrate. The air flow in the air classifier is set to ensure that heavy metal components are not entrained in the air stream, but instead fall through the classifier and end up in the heavy fraction. This air flow rate should be set to drop in the heavy fraction all the heavy constituents that could damage a grinder. Consequently, some copper wire will be present in the heavy fraction. The copper wire that ends up as part of the heavy fraction is thick gauge bare copper wire that typically represent less than 5 percent of the total copper wire in the copper wire concentrate. This thick gauge bare copper wire may represent up to 50 percent of the metal constituents present in the heavy fraction. The airflow should entrain most, if not all, of the copper wire that has at least some insulation. Other light materials, such as foam and wood, that contaminated the copper wire concentrate also are in the light fraction. However, these constituents do not pose a damage risk to grinder blades.

The heavy fraction, which includes heavier metal constituents that contaminated the copper wire concentrate, may be returned to step 202 for further processing to recover any valuable recyclable metals. For example, the process 200 may include processing the heavy fraction to recover the non-copper metal component (e.g., stainless steel, lead, etc.).

The light fraction is processed at step 230 in one or more grinders, such as the one or more grinders 130, to separate the copper wire from the insulation covering the copper wire to produce bare copper metal. If the one or more grinders 130 include multiple grinders, the individual grinders of the one or more grinders 130 may be arranged in series. That is, the light fraction produced at step 220 would be processed in a first grinder of the one or more grinders 130 to produce a first ground material. The first ground material produced by the first grinder of the one or more grinders 130 is then processed in a second grinder of the one or more grinders 130. In general, if the one or more grinders 130 include multiple grinders, the ground material produced by each one of the grinders of the one or more grinders 130, with the exception of the ground material produced by the last grinder in the series, is fed to an immediately subsequent grinder of the one or more grinders 130. At step 230, the one or more grinders 130 liberate the bare copper metal from the insulation material surrounding the copper metal producing a mixture of bare copper metal and the insulation material. In some example embodiments, the process 200 may include, at step 240, separating the mixture of bare copper metal and the insulation material produced at step 230 from each other. To illustrate, at step 240, the liberated bare copper metal and the insulation constituents (and other light contaminants such as foam and wood) from step 230 can be separated one from another by known technologies such as density-based separation using the one or more density separators 140 taking advantage of the significant density difference between copper and the insulation and other light materials. The bare copper metal product can be sold. The process 200 ends at step 299.

Because the sizes of the constituents of the copper wire concentrate are reduced by the shredder 110 at step 210 and because constituents that could damage the one or more grinders 130 are removed at step 220, the light fraction produced at step 220 can be processed with a significantly reduced risk of damage to the one or more grinders 130 to produce bare copper metal.

One of ordinary skill in the art would appreciate that the present disclosure provides systems and methods for producing a bare copper wire product from a copper wire concentrate produced from the processing of ASR and that may be contaminated by heavier metal constituents that would damage traditional grinders.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A method for recovering bare copper metal from an ASR copper wire concentrate comprising steps of:
receiving ASR copper wire concentrate comprising a copper wire component and a non-copper metal component, the copper wire component comprising copper metal and an insulation material, wherein the non-copper metal component has a density greater than the density of copper, a hardness value greater than a hardness value of copper, or a thickness greater than the thickness of the copper wire component;
processing the ASR copper wire concentrate in a shredder to produce shredded ASR copper wire concentrate;
separating the shredded ASR copper wire concentrate into a light fraction and a heavy fraction using an air classifier, wherein the light fraction comprises the copper wire component and wherein the heavy fraction comprises the non-copper metal component; and
processing the light fraction in a grinder to liberate the copper metal of the copper wire component from the insulation material.

2. The method of claim 1, further comprising a step of further processing the heavy fraction to recover the non-copper metal component.

3. The method of claim 1, wherein the shredder is a hammer mill.

4. The method of claim 1, wherein the shredder is a ring mill.

5. The method of claim 1 wherein the step of processing the light fraction in a grinder comprises steps of:
processing the light fraction in a first grinder to liberate the copper metal of the copper wire component from the insulation material producing ground material; and
processing the ground material in a second grinder.

6. A system for recovering bare copper metal from an ASR copper wire concentrate, the system comprising:
a shredder for processing the ASR copper wire concentrate, the ASR copper wire concentrate comprising a copper wire component and a non-copper metal component, the copper wire component comprising copper metal and an insulation material, wherein the non-copper metal component has a density greater than the density of copper, a hardness value greater than a hardness value of copper, or a thickness greater than the thickness of the copper wire component;
an air classifier for separating the shredded ASR copper wire concentrate into a light fraction and a heavy fraction, wherein the light fraction comprises the copper wire component and wherein the heavy fraction comprises the non-copper metal component; and
a grinder for processing the light fraction to liberate the copper metal of the copper wire component from the insulation material.

7. The system of claim 6, wherein the shredder is a hammer mill.

8. The system of claim 6, wherein the shredder is a ring mill.

9. The system of claim 6, wherein the grinder comprises a plurality of grinders arranged in series to provide ground material produced by one grinder of the plurality of grinders to an immediately subsequent grinder further processed by a second grinder of the plurality of grinders.
